(19) United States
(12) Patent Application Publication
(10) Pub. No.: US 2011/0307826 A1
(43) Pub. Date: Dec. 15, 2011

(54) USER INTERFACE WITH MOUSE-OVER FUNCTION

(75) Inventors: Krisela Rivera, Sunnyvale, CA (US); Aurore Thomas-Mourier, San Jose, CA (US); Victor Chavez, San Jose, CA (US); Matt Weathers, Palo Alto, CA (US); Liem Duy Nguyen, San Jose, CA (US)

(73) Assignee: eBay Inc., San Jose, CA (US)

(21) Appl. No.: 13/101,885

(22) Filed: May 5, 2011

Related U.S. Application Data
(60) Provisional application No. 61/353,167, filed on Jun. 9, 2010.

(51) Int. Cl. G06F 3/048

(52) U.S. Cl. 715/784; 715/802

(57) ABSTRACT

Systems and methods to provide a user interface with a mouse-over function are provided. A system may comprise a detecting module to detect a user interface event received from a user device and to detect an event type. A pointer is detected as being within an area of interest of a plurality of areas of interest in the user interface upon determining that the event type is an update pointer event location. A rendering module populates a mini-view with mini-view data corresponding to the area of interest selected by virtue of the location of the pointer.

This application claims the priority benefit of U.S. Provisional Application No. 61/353,167, filed Jun. 9, 2010 and entitled “USER-INTERFACE WITH MOUSE-OVER FUNCTION,” which is incorporated herein by reference.

### TECHNICAL FIELD

This application relates to the field of network-based commerce and, more specifically, to a user interface with a mouse-over function.

### BACKGROUND

With the widespread acceptance of the Internet as a medium for commerce, it has become increasingly important for businesses to deploy e-commerce websites that provide a high-quality shopping experience. Because a user interface provides the mechanisms by which a user (e.g., customer) interacts with the website, the user interface forms a large part of the user experience and is therefore critical to the success of an e-commerce website. For example, a user interface that requires many user actions (e.g., mouse clicks) and webpage downloads in order to browse products may hinder browsing and, thereby, limit the number of potential sales. Also, if it is difficult or time consuming to compare like products (e.g., products returned by a search), the user may become frustrated and then abandon the website. Likewise, the user may abandon the website if browsing is too cumbersome or burdensome (e.g., browsing requires many mouse clicks and switching back and forth among many webpages) or if browsing takes excessive time (e.g., because of excessive webpage loading). For e-commerce web sites, these consequences may result in a loss of revenue. It is therefore critical to have a user interface that requires minimal user actions and webpage loading and that provides a central location to compare like products.

Conventional systems may provide an enlarged view of a product from a product list (e.g., a search results list), without loading a new page, when the user selects the product by clicking on it with a pointing device. However, to see additional information concerning the product, such as product description or contact information, the user must also click on a link to a webpage of the product, thereby navigating away from the product list page. To once again see the product list, the user must then navigate back to the product list page. In doing so, the webpage being viewed no longer displays the additional information of the previously selected product. In effect, the user must navigate back and forth between the product list page and the individual product pages to compare product details.

### BRIEF DESCRIPTION OF DRAWINGS

Embodiments of the present invention are illustrated by way of example and not limitation in the figures of the accompanying drawings, in which like reference numbers indicate similar elements.

FIG. 1 is a block diagram of an example embodiment of a mouse-over system for electronic resources.

FIG. 2 is a network diagram depicting a client-server system, within which one example embodiment may be deployed.

FIG. 3 is a block diagram illustrating modules of an application serving platform used in controlling the user interface, as may be used in an example embodiment.

FIG. 4 is a workflow diagram illustrating a basic interaction between user interface events and a user interface, according to an example embodiment.

FIG. 5 depicts a portion of an example user interface having a mouse-over function.

FIG. 6 depicts a portion of an example mini-view triggered by a mouse-over action.

FIG. 7 depicts a portion of an example mini-view for sending a message.

FIG. 8 depicts a portion of an example search results page having mouse-over functionality.

FIG. 9 is a diagrammatic representation of a machine in the example form of a computer system within which set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details. Further, well-known instruction instances, protocols, structures, and techniques have not been shown in detail.

In one aspect, a user interface may cause additional information concerning a product from a product list to be displayed within a mini-view, when the additional information is not otherwise displayed within the webpage containing the product list (product list page). The additional information may include a brief description and contact information. Additionally, the user may be able to communicate with, for example, the seller of the product via the mini-view. The mini-view is populated with the additional information about a product when a mouse-over event occurs. In effect, the mini-view may improve the user experience of the website because the user may obtain additional information about a product without clicking on the product with a pointing device or without loading or navigating to the webpage of the product. Furthermore, the mini-view may also provide the user with a means to communicate with entities associated with the product (e.g., a seller of the product) without loading or navigating to the webpage of the product. Still further, the user interface may render the mini-view in such a way that it is always in full view of the user when the product list is shown, for example, as the user scrolls through the product list. The above-recited capabilities may allow the user to browse more products in a given time and reduce incidence of the user navigating away from the website without making a purchase, thereby possibly increasing revenue for a content provider, such as an e-commerce site.

Further details regarding the various example embodiments described above will now be discussed with reference to the figures.

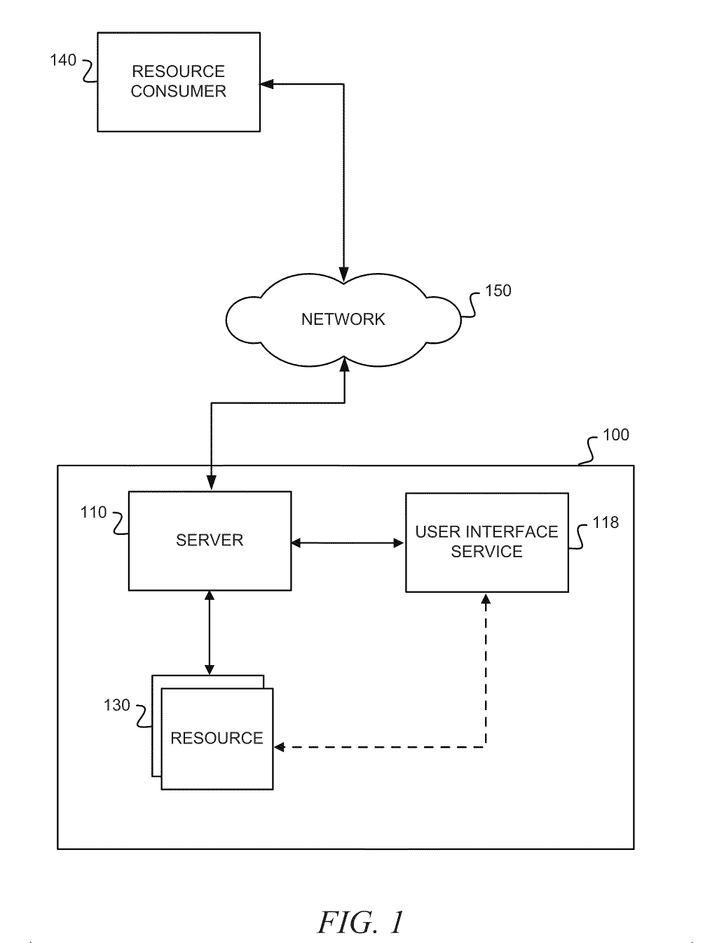

FIG. 1 is a block diagram of an example embodiment of a mouse-over system 100 for electronic resources. System 100 may include a server 110, a user interface service 118, and an electronic resource 130. The system 100 may be connected to a network 150, such as, for example, the Internet or a local area network (LAN). The server 110 may be coupled to the user interface service 118 and the electronic resource 130. The server 110 may comprise a computer running administrative software that controls access to the system 100 and the resources 130, and further allocates resources 130 to the user interface service 118 and the resource consumer 140 on the network 150. The electronic resource 130 may include a part of a computer system or network, such as a central processing unit (CPU), disk drive, printer or memory that can be allotted to a program or process while it is running The user interface service 118 may be logically coupled to the electronic resource 130 to generate user interfaces (e.g., webpages, or portions of webpages) instrumented to allow mouse-over features, as described further below.

A resource consumer 140 (e.g., a user device) may connect to the server 110 through the network 150 to request the electronic resource 130. The server 110 may inform user interface service 118 of the request and receive the instrumented user interface from the user interface service 118.

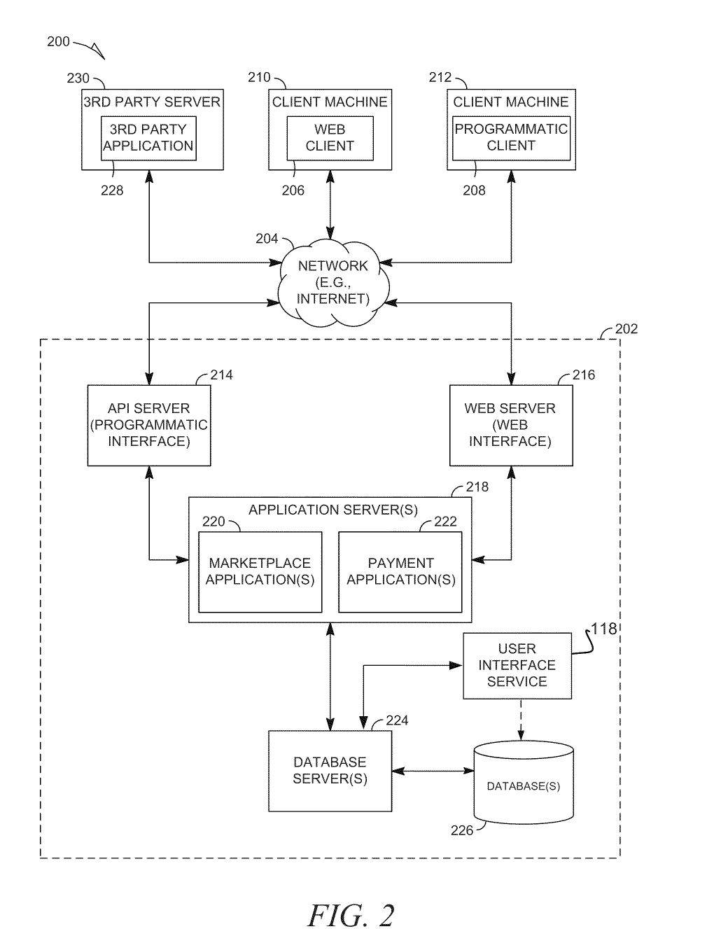

FIG. 2 is a network diagram depicting a client-server system 200, within which one example embodiment may be deployed. A networked system 202, in the example forms of a network-based marketplace or publication system, provides server-side functionality, via a network 204 (e.g., the Internet or wide area network (WAN)) to one or more clients. The network 204 may be the network 150 of FIG. 1. FIG. 2 illustrates, for example, a web client 206 (e.g., a browser) and a programmatic client 208 executing on respective client machines 210 and 212. The client machines 210 and 212 are examples of the resource consumer 140 of FIG. 1.

An Application Program Interface (API) server 214 and a web server 216 are coupled to, and provide programmatic and web interfaces respectively to, one or more application servers 218. The API server 214 and/or the web server 216 are examples of the server 110 of FIG. 1. The application servers 218 host one or more marketplace applications 220 and payment applications 222. The application servers 218 are, in turn, shown to be coupled to one or more databases servers 224 that facilitate access to one or more databases 226. The application servers 218, database servers 224, and the databases 226 are examples of electronic resources 130. The database servers 224 may further be coupled to the user interface service 118 of FIG. 1.

The marketplace applications 220 may provide a number of marketplace functions and services to users that access the networked system 202. The payment applications 222 may likewise provide a number of payment services and functions to users. The payment applications 222 may allow users to accumulate value (e.g., in a commercial currency, such as the U.S. dollar, or a proprietary currency, such as “points”) in accounts, and then to later redeem the accumulated value for products (e.g., goods or services) that are made available via the marketplace applications 220. While the marketplace and payment applications 220 and 222 are shown in FIG. 2 to both form part of the networked system 202, it will be appreciated that, in alternative embodiments, the payment applications 222 may form part of a payment service that is separate and distinct from the networked system 202.

Further, while the system 200 shown in FIG. 2 employs a client-server architecture, the present invention is of course not limited to such an architecture, and could equally well find application in a distributed, or peer-to-peer, architecture system, for example. The various marketplace and payment applications 220 and 222 could also be implemented as standalone software programs, which do not necessarily have networking capabilities.

The web client 206 accesses the various marketplace and payment applications 220 and 222 via the web interface supported by the web server 216. Similarly, the programmatic client 208 accesses the various services and functions provided by the marketplace and payment applications 220 and 222 via the programmatic interface provided by the API server 214. The programmatic client 208 may, for example, be a seller application (e.g., the TurboLister application developed by eBay Inc., of San Jose, Calif.) to enable sellers to author and manage listings on the networked system 202 in an off-line manner, and to perform batch-mode communications between the programmatic client 208 and the networked system 202.

FIG. 2 also illustrates a third party application 228, executing on a third party server machine 230, as having programmatic access to the networked system 202 via the programmatic interface provided by the API server 214. For example, the third party application 228 may, utilizing information retrieved from the networked system 202, support one or more features or functions on a website hosted by the third party. The third party website may, for example, provide one or more promotional, marketplace or payment functions that are supported by the relevant applications of the networked system 202.

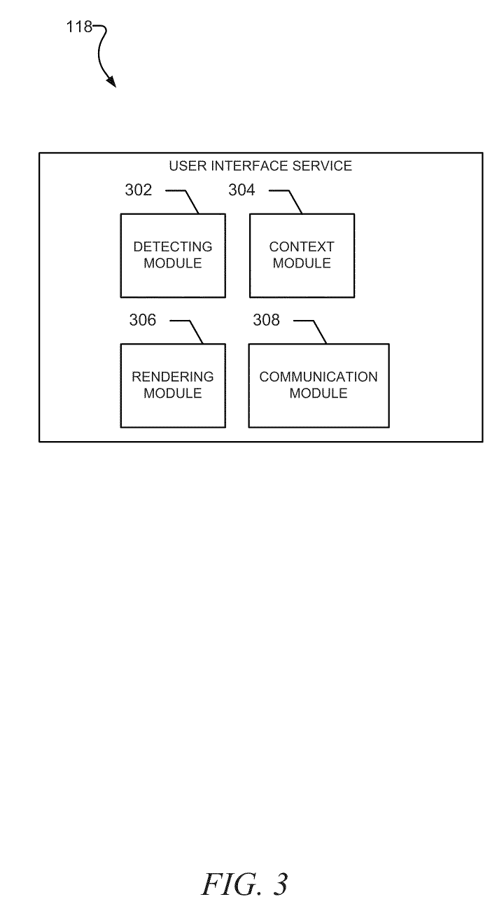

FIG. 3 is a block diagram illustrating example modules of the user interface service 118 used to provide a mini-view within a webpage, according to an example embodiment. FIG. 3 shows the user interface service 118 including a detecting module 302, a context module 304, a rendering module 306 and a communication module 308. The modules within the user interface service 118 may be implemented as hardware modules having one or more processors, as software module for execution on one or more processors, or a combination thereof.

The detecting module 302 is configured to detect a received user interface event. A user interface event may include the user moving a cursor, typing text, clicking a button, or some other interaction with the displayed user interface. In instances where the user interface event is received from a touch screen device, the user interface event may include a user holding a finger stationary, or performing a predefined gesture, at an element in the displayed interface. In some instances, the user interface event may be detected in response to a changed state of the user interface or by blocking for notification of the occurrence of the user-interface event (e.g., blocking on a semaphore or other operating system construct). The detecting module 302 is further configured to determine a type of the received user interface event. The user interface event types may include “update pointer location,” “initialize communication,” “terminate communication,” “scroll,” or any other event. Depending on the type of the event, the user interface service 118 may perform additional tasks.

The context module 304 is configured to determine a current state, or context, of the user interface. For example, the context module 304 detects whether the pointer location is within an area of interest (AOI) of the displayed user interface. An AOI is a location or set of locations within the user interface where a mouse-over function is activated when the pointer (controlled by a mouse) is located in that location. To be considered as being in an AOI, the pointer may have to be in the AOI or within a certain portion of the AOI for a threshold period of time (e.g., 1 millisecond (ms), 10 ms, 100 ms, or 1 second). In some instances, the cursor being in a particular AOI may cause the mini-view to be frozen. The particular AOI that causes the mini-view to be frozen is referred to as a null AOI.

Further, the context module 304 may determine whether a displayed mini-view is in a frozen state or whether to freeze a displayed mini-view. Freezing the mini-view may include preventing at least some portion of the mini-view from being updated. To illustrate, the context module 304 may freeze the mini-view when the user has entered text in the message text box of a communication interface in the mini-view but has not sent or canceled the message. In such a case, the context module 304 may prevent the mini-view from being updated with mini-view data associated with another advertisement. The context module 304 may allow the user to interact with the communication interface within the mini-view while other portions of the mini-view remain frozen. Conversely, the context module 304 may unfreeze the mini-view when, for example, the user has sent the message, canceled the message, or deleted all text from the message text box.

The rendering module 306 is configured to populate the mini-view with mini-view data corresponding to the AOI activated by virtue of the location of the pointer. In an example embodiment, relative to an advertisement, the mini-view data includes additional information not shown in the advertisement. As an example, the advertisement may simply show a picture and a title, while the mini-view data includes pricing information, location, brief description, and a picture (e.g., a higher-quality version of the advertisement picture). The rendering module 306 may generate the mini-view data by processing (e.g., via a client-side script) data embedded in the webpage. In other example embodiments, the rendering module 306 may generate the mini-view data by requesting data from the server 110. In some instances, the rendering module 306 may scroll the display of the webpage but move the mini-view relative to the webpage so that the mini-view remains fully in view.

The user interface service 118 may present a communication interface to the user by causing the rendering module 306 to enable the mini-view to receive user data, and by initializing the communication module 308 to support any resulting communication. In an example embodiment, the rendering module 306 may cause an email address text box, a message text box, and a send button to be usable within the mini-view. In another example embodiment, the communication module 308 may cause a communication channel to be opened to transmit and receive voice or video data over the Internet. The communication channel may be used to facilitate real-time communication, such as a video conference, teleconference, or instant messaging session.

The communication module 308 is configured to transmit buffered user data. In an example embodiment, the communication module 308 may cause communication channels to be opened, may cause the user data to be transmitted, and then may cause the connections to be closed. Also, the rendering module 306 may disable the communication interface.

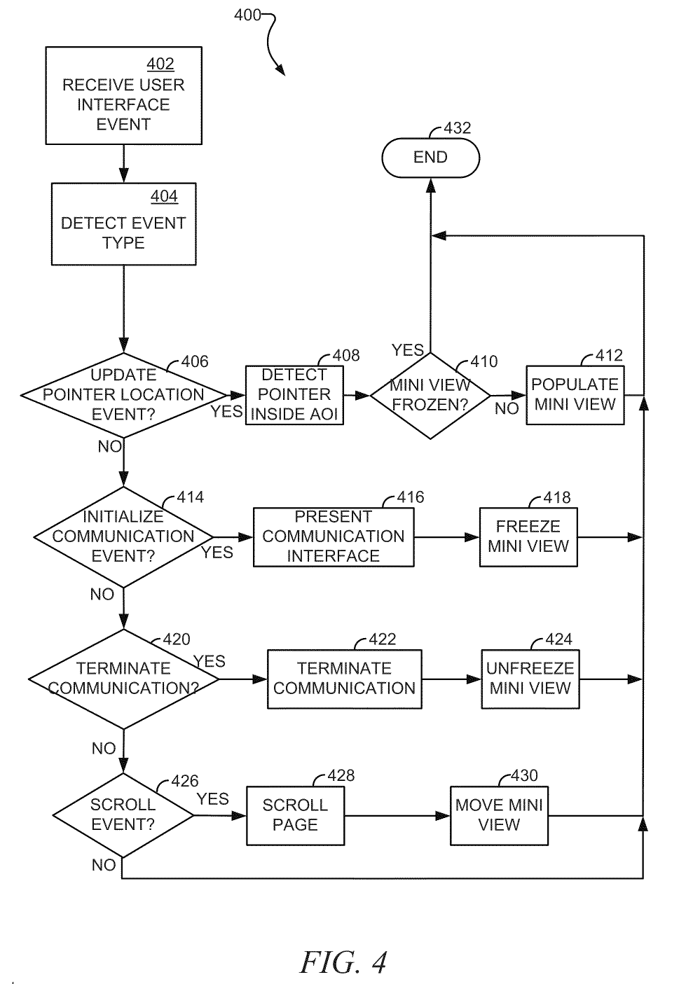

FIG. 4 is a flow diagram showing a method 400 of providing a mini-view within a webpage, according to one example embodiment. The method 400 may be performed by the user interface service 118 and its modules.

At operation 402, the detecting module 302 detects a received user-interface event. In an example embodiment, the detecting module 302 may receive the user-interface event by detecting changing states of the user interface (e.g., polling for events generated by the web browser) or by blocking for notification of the occurrence of the user-interface event (e.g., blocking on a semaphore or other operating system construct).

At operation 404, the detecting module 302 determines the type of the user-interface event. Example embodiments may specify different user-interface events to facilitate improved and easier handling of the received user-interface events. As an example, a specific type of user-interface event may direct the user-interface service 118 to perform a specific action, as further described below. The user-interface event types may include update pointer location, initialize communication, terminate communication, scroll, or any other event.

At decision 406, the user interface service 118 determines whether the user-interface type is an update pointer location event. If yes, method 400 continues to operation 408. If no, method 400 continues to operation 414.

At operation 408, the context module 304 detects whether the pointer location is within an AOI. If the pointer location is within an AOI, the method 400 continues to decision 410.

In an example embodiment, at decision 410, the context module 304 may determine whether the mini-view is frozen. The mini-view may be frozen by virtue of the pointer being located in a null AOI or by virtue of user interface events detected in the mini-view. If the mini-view is not frozen, the method 400 continues to operation 412. As is described below, freezing the mini-view may prevent at least some portion of the mini-view from being updated.

At operation 412, the rendering module 306 populates the mini-view with mini-view data, with the mini-view data including information related to the AOI. Where the AOI corresponds to a search result (e.g., an item or product listing), the mini-view data includes additional information not shown in the search result or options to contact the seller. In an example embodiment, relative to an advertisement, the mini-view data includes additional information not shown in the advertisement. As an example, the advertisement may simply show a picture and a title, while the mini-view data includes pricing information, location, brief description, and a picture (e.g., a higher-quality version of the advertisement picture). The rendering module 306 may generate the mini-view data by processing (e.g., via a client-side script) data embedded in the webpage. In other example embodiments, the rendering module 306 may generate the mini-view data by requesting data from the server 110.

At decision 414, the user interface service 118 determines whether the event type detected at operation 404 is an “initialize communication” interface event. If yes, method 400 continues to operation 416. If no, method 400 continues to operation 420.

At operation 416, the user interface service 118 presents a communication interface for the user by causing the rendering module 306 to enable the mini-view to receive user data and by initializing the communication module 308 to support any resulting communication. In an example embodiment, the rendering module 306 may cause an email address text box, a message text box, and a send button to be usable within the mini-view. In another example embodiment, the communication module 308 may cause a communication channel to be opened to transmit and receive voice or video data over the Internet.

At operation 418, the context module 304 freezes the mini-view. As an example of freezing the mini-view, the context module 304 may prevent at least some portion of the mini-view from being updated. To illustrate, the context module 304 may freeze the mini-view when the user has entered text in the message text box of the communication interface but has not sent or canceled the message. In such a case, the context module 304 may prevent the mini-view from being updated with mini-view data associated with another advertisement. However, in this case, the context module 304 may allow the user to interact with the communication interface. Conversely, the context module 304 may unfreeze the mini-view when, for example, the user has sent the message, canceled the message, or deleted all text from the message text box.

At decision 420, the user interface service 118 determines whether the user-interface type detected at operation 404 is a terminate communication event. If yes, method 400 continues to operation 422. If no, method 400 continues to operation 426.

At operation 422, the communication module 308 may transmit buffered user data. In an example embodiment, the communication module 308 may cause communication channels to be opened, may cause the user data to be transmitted, and then may cause the connections to be closed. Also, the rendering module 306 may disable the communication interface.

At operation 424, the context module 304 may unfreeze the mini-view, allowing the mini-view to be updated based on the location of the pointer.

At decision 426, the user interface service 118 determines whether the user-interface type detected at operation 404 is a scroll event. If yes, method 400 continues to operation 428.

At operation 428, the rendering module 306 may scroll the display of the webpage, and, in an operation 430, move the mini-view relative to the webpage so that the mini-view remains fully in view. The mini-view may be frozen while the page is scrolled until an update pointer location event or other user interface event is detected.

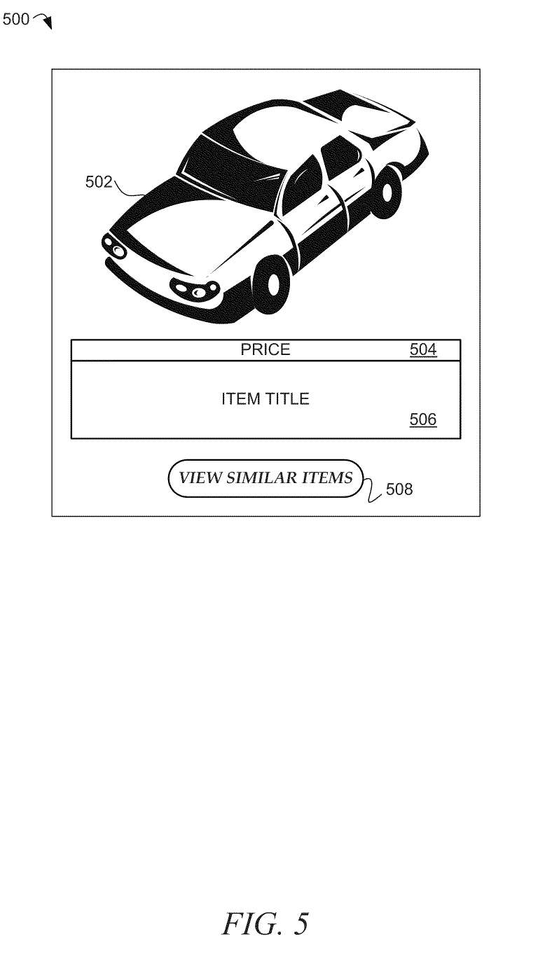

FIG. 5 depicts a portion 500 of an example user interface having a mouse-over function. The portion 500 may be displayed as a search result in a search results page generated in response to a query submitted by a user via the resource consumer 140 or the client machines 210 and 212. The portion 500 includes, for example, a first image 502 of the item for sale, a first field 504 to display a price of the item, a second field 506 to display the title of the item, and a button 508 selectable by the user to trigger a new search for items similar to the item depicted in the portion 500. All or part of the portion 500 may be an AOI in the user interface. In some instances, only portions of the portion 500 are an AOI. For example, the first image 502, the first field 504, and the second field 506 may comprise the AOI. The button 508 may be excluded from the AOI. The remainder of the portion 500 may or may not be included in the AOI.

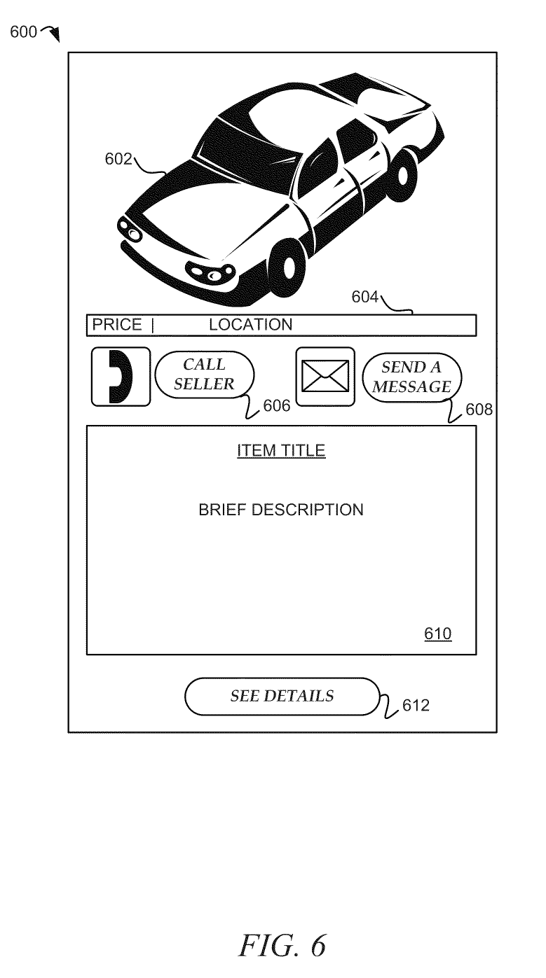

FIG. 6 depicts a portion 600 of an example mini-view triggered by a mouse-over action. The portion 600 may be presented to the user if a pointer location event is detected in an AOI of the portion 500. The portion 600 may be presented in a designated area of the user interface so as not to replace other portions of the user interface, such as additional portions similar to portion 500 representing additional search results. The portion 600 may be frozen or unfrozen.

The portion 600 comprises a second image 602 of the item for sale, a first field 604 indicating a price and location of the item for sale, a first button 606, that when selected by the user, initiates a telephone call to the seller and freezes the mini-view, and a second button 608, that when selected by the user, initiates a communication interface for sending a message to the seller and freezes the mini-view. The portion 600 may include further interactive features to allow a user to, for example, initiate a bid on the item for sale, initiate a purchase of the item for sale, initiate a watch of the item for sale, save the item for sale in a wishlist, send the description of the item for sale to a friend, or post the description of the item for sale in a social network. The portion 600 includes a second field 610 that includes the item title and a brief description of the item and a third button 612 that allows a user to navigate to a page having more details about the item.

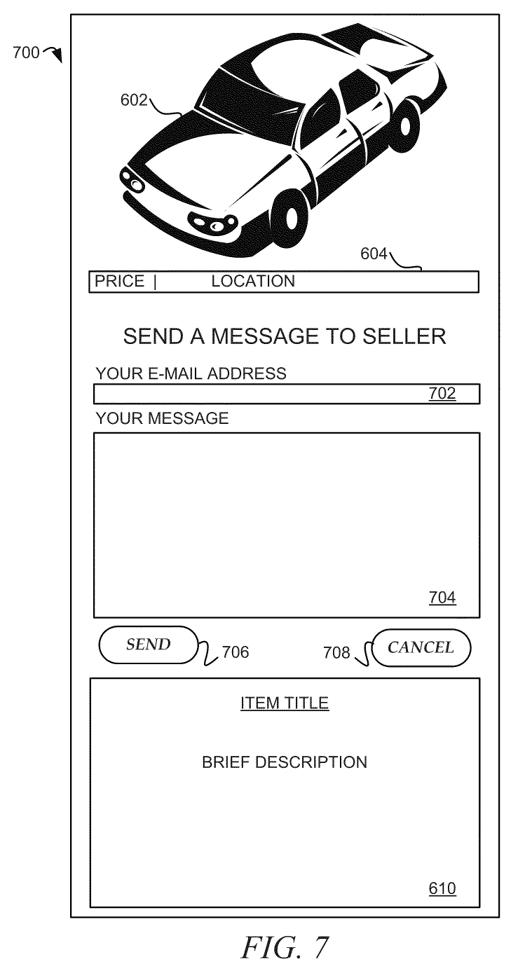

FIG. 7 depicts a portion 700 of an example communication interface of the mini-view for sending a message. The portion 700 may be provided if a user selects the second button 608 to initiate sending a message to the seller and the mini-view is frozen. The portion 700 includes a first field 702 where the user provides his email address. The user enters a message into message field 704. The user may then select a first button 706 to send the message to the seller or a second button 708 to cancel the message. After the user selects the first button 706 or the second button 708, the mini-view may return to portion 600.

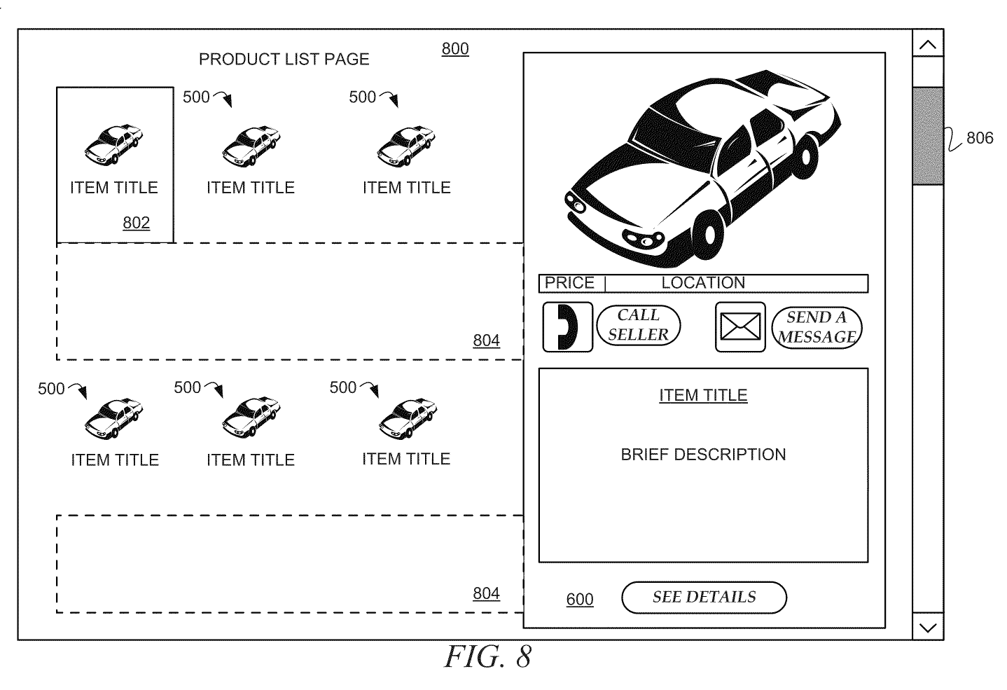

FIG. 8 depicts a portion 800 of an example product list page having mouse-over functionality. The product list page may be a search results page generated in response to a query or a pre-assembled list of items for sale. The portion 800 includes a selected portion 802. The user selects the selected portion 802 by positioning a pointer over an AOI of the portion 500, which is then selected. Upon selection of the portion 802, the portion 600 (mini-view) corresponding to the portion 802 is provided along the right side of the screen so as not to obscure other portions 500 of the product list page.

The fields 804 represent null AOIs within the product list page. The null AOIs may not be shown to the user but are used by the user to move a pointer from the selected portion 802 to the mini-view of portion 600. When the pointer is located in the null AOI 804, the mini-view may be frozen.

The scroll 806 allows a user to scroll to additional portions 500 located further down the product list page. If the user scrolls without selecting a new portion 500, the mini-view is frozen on the current selected portion 802. When the user scrolls, the mini-view remains fully visible and moves with the scrolling of the page.

### Example Machine Architecture and Machine-Readable Medium

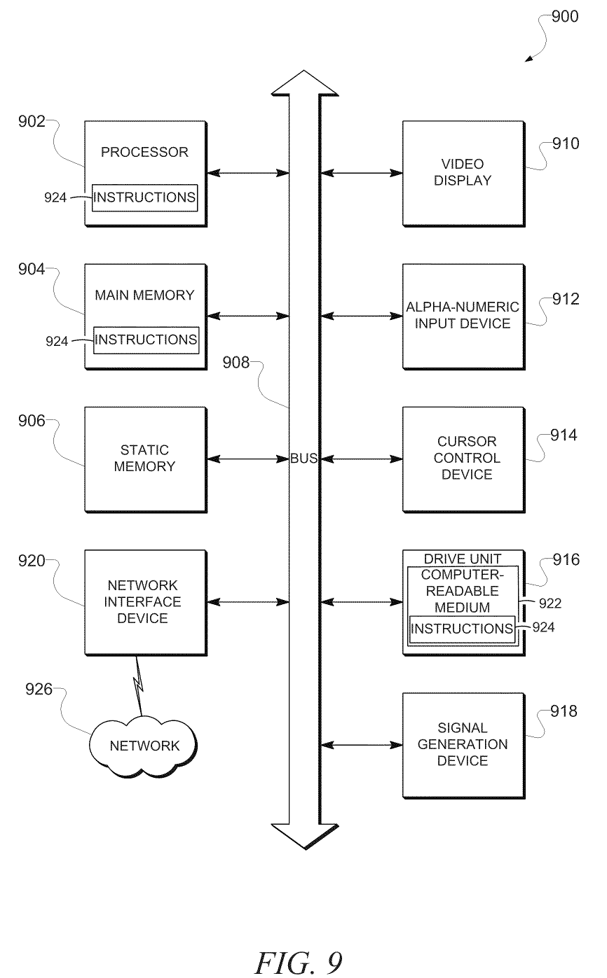

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or client device in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a CPU, a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Storage Medium

The disk drive unit 916 includes a machine-readable storage medium 922 on which is stored one or more sets of instructions 924 and data structures (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media.

While the machine-readable storage medium 922 is shown in an example embodiment to be a single medium, the term “machine-readable storage medium” may include a single medium or multiple media (e.g., a centralized or distributed database, and/or associated caches and servers) that store the one or more instructions 924 or data structures. The term “machine-readable storage medium” shall also be taken to include any tangible medium that is capable of storing, encoding or carrying instructions for execution by the machine and that causes the machine to perform any one or more of the methodologies of the present invention, or that is capable of storing, encoding or carrying data structures utilized by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices, (e.g., erasable programmable read-only memory (EPROM), electrically erasable programmable read-only memory (EEPROM), and flash memory devices); magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., Hypertext Transfer Protocol (HTTP)). Examples of communication networks include a LAN, a WAN, the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Modules, Components and Logic

Certain embodiments are described herein as including logic or a number of components, modules, or mechanisms (e.g., collectively referred to as “components” hereinafter). A component is a tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein

In various embodiments, a component may be implemented mechanically or electronically. For example, a component may comprise dedicated circuitry or logic that is permanently configured (e.g., as a special-purpose processor) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software), may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiples of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation and store the output of that operation in a memory device to which it is communicatively coupled. A further component may then, at a later time, access the memory device to retrieve and process the stored output. Components may also initiate communications with input or output devices, and can operate on a resource (e.g., a collection of information).

Although certain specific example embodiments are described herein, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments are described and illustrated in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a detecting module configured to detect a user interface event received from a user device and to detect an event type;
a context module configured to detect a pointer as being within an area of interest of a plurality of areas of interest in the user interface upon determining that the event type is an update pointer event location; and
a rendering module configured to populate a mini-view with mini-view data corresponding to the area of interest selected by virtue of the location of the pointer.

2. The system of claim 1, further comprising a communication module configured to provide a communication interface within the mini-view, the communication interface to receive user data within the mini-view.

3. The system of claim 2, wherein the communication module is further to transmit a communication generated based on the received user data and data displayed in the area of interest.

4. The system of claim 1, wherein the rendering module is configured to generate the mini-view and to position the mini-view so as to not obstruct the plurality of the areas of interest in the user interface.

5. The system of claim 1, wherein the rendering module is configured to scroll the display of the user interface and to move the mini-view relative to the user interface so that the mini-view stays in view as the display is scrolled.

6. The system of claim 1, wherein the context module is configured to determine that the mini-view is frozen.

7. The system of claim 1, wherein the context module is configured to freeze the mini-view based on a communication interface generated within the mini-view.

8. The system of claim 7, wherein the context module is further configured to unfreeze the mini-view based on a termination of the communication interface.

9. The system of claim 1, wherein the context module is configured to freeze the mini-view based on detection of an update pointer location event in a null area of interest.

10. The system of claim 1, wherein the area of interest corresponds to a description of an item for sale.

11. A method comprising:
detecting a user interface event received from a user device;
detecting an event type of the user interface event;
detecting a pointer as being within an area of interest of a plurality of areas of interest in the user interface upon determining that the event type is an update pointer event location; and
populating a mini-view with mini-view data corresponding to the area of interest selected by virtue of the location of the pointer.

12. The method of claim 11, further comprising providing a communication interface within the mini-view, the communication interface to receive user data within the mini-view.

13. The method of claim 12, further comprising transmitting a communication generated based on the received user data and data displayed in the area of interest.

14. The method of claim 11, further comprising positioning the mini-view so as to not obstruct the plurality of the areas of interest in the user interface.

15. The method of claim 11, further comprising moving the mini-view relative to a scrolling of the display of the user interface so that the mini-view stays in view as the display is scrolled.

16. The method of claim 11, further comprising determining that the mini-view is frozen.

17. The method of claim 11, further comprising freezing the mini-view based on a communication interface generated within the mini-view.

18. The method of claim 17, further comprising unfreezing the mini-view based on a termination of the communication interface.

19. The method of claim 11, further comprising freezing the mini-view based on detection of an update pointer location event in a null area of interest.

20. The method of claim 11, wherein the area of interest corresponds to a description of an item for sale.

21. A non-transitory machine-readable medium having instructions embodied thereon, the instructions executable by one or more processors to perform a method, the method comprising:
detecting a user interface event received from a user device;
detecting an event type of the user interface event;
detecting a pointer as being within an area of interest of a plurality of areas of interest in the user interface upon determining that the event type is an update pointer event location; and
populating a mini-view with mini-view data corresponding to the area of interest selected by virtue of the location of the pointer.
